(19) United States
(12) Patent Application Publication
(10) Pub. No.: US 2017/0192819 A1
(43) Pub. Date: Jul. 6, 2017

(54) METHOD AND ELECTRONIC DEVICE FOR RESOURCE ALLOCATION

(71) Applicants: Le Holdings (Beijing) Co., Ltd., Beijing (CN); Lemobile Information Technology (Beijing) Co., Ltd., Beijing (CN)

(72) Inventor: Guofeng Xie, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/242,758

(22) Filed: Aug. 22, 2016

Related U.S. Application Data
(63) Continuation of application No. PCT/CN2016/088547, filed on Jul. 5, 2016.

(30) Foreign Application Priority Data
Dec. 31, 2015 (CN) 201511031627.4

(51) Int. Cl. G06F 9/50; G06F 9/54

(52) U.S. Cl. CPC G06F 9/5011; G06F 9/541

(57) ABSTRACT

This disclosure discloses a method and electronic device for resource allocation. The method includes the following steps: acquiring a resource allocation request of multiple applications, wherein the requested resources in the resource allocation request are determined according to a current usage scenario; acquiring the priority of each disclosure according to the current usage scenario; and allocating the requested resources to the applications successively according to the levels of the priorities. The present disclosure can not only ensure that a mobile terminal has good user experience in various usage scenarios, but also further reduce the energy consumption of the mobile terminal and prolong the endurance time of the mobile terminal

### CROSS REFERENCE TO RELATED APPLICATIONS

This disclosure is a continuation of International Application No. PCT/CN2016/088547 filed on Jul. 5, 2016, which is based upon and claims priority to Chinese Patent Application No. 201511031627.4, filed on Dec. 31, 2015, titled “METHOD AND DEVICE FOR RESOURCE ALLOCATION”, and the entire contents of which are incorporated herein by reference.

### TECHNICAL FIELD

This disclosure relates to the technical field of smart mobile terminals, and specifically relates to a method and electronic device for resource allocation.

### BACKGROUND

At present, the performance of a smart mobile terminal has reached a very high level, but the endurance time of the smart mobile terminal is getting shorter and shorter. Before a new breakthrough in the development of the battery technology, a variety of power saving technologies on the smart mobile terminals can correspondingly extend the partial service lives of batteries, and temporarily solve the problem of short endurance time at present.

But at present, for the smart mobile terminals, including smart phones, there is no global power saving strategy, but generally only power saving in a single usage scenario is optimized. However, there are various usage scenarios existing in the smart mobile terminals, for example, there is only a video playing disclosure operating in a visual interface of a smart mobile terminal, meanwhile QQ and WeChat, etc. being receiving an instant message, etc. in the background, and some other background applications. For another example, there is only a QQ disclosure operating in the visual interface, meanwhile an operation such as downloading, running in the background. If power saving is optimized for only one or a few of the usage scenarios thereof, it will often inevitably lead to caring for this and losing that, and cannot achieve a good effect.

In addition, in the process of power saving optimization, if the performance of a terminal in the current service environment is influenced, for example, video freezing is caused when playing a video, or at this time, the QQ and WeChat, etc. in the background cannot receive messages. At this point, even if the power saving has been optimized, but the user experience is influenced.

Therefore, it is preferred to guarantee the performance in various usage scenarios, namely prolonging the endurance time of a mobile phone on the premise of guaranteeing the user experience, which is a technical problem in urgent need of solution.

### SUMMARY

This disclosure provides a method and electronic device for resource allocation to further reduce the energy consumption and prolong the endurance time of a mobile terminal while guaranteeing good user experience of the mobile terminal in various usage scenarios.

One objective of the embodiments of this disclosure is to provide a method for resource allocation, includes the following steps: acquiring resource allocation requests of multiple applications, where the requested resources in the resource allocation requests are determined according to a current usage scenario; acquiring the priority of each of the applications according to the current usage scenario; and allocating the requested resources to the applications successively according to the levels of the priorities.

Preferably, the resources comprise a CPU resource, a graphics processor resource and a dynamic memory bandwidth.

Preferably, before the step of acquiring a resource allocation request of multiple applications, the method also includes:

pre-determining the priority of each of the applications in each of the usage scenarios; and

pre-allocating the resources to each of the applications in each of the usage scenarios.

Preferably, the step of allocating the requested resources to the applications successively according to the levels of the priorities includes:

establishing priority linked lists according to the number of the levels of the priorities, where each priority linked list corresponds to a different level of priority;

acquiring priority linked lists having the same levels of the priorities as those of the applications according to the priorities of the applications;

placing identifiers of the applications into the priority linked lists; and

allocating resources to the applications corresponding to the identifiers in each of the priority linked lists successively according to the levels of the priorities of the priority linked lists.

Preferably, after the step of allocating the requested resources to the applications successively according to the levels of the priorities, the method further includes: deleting the identifiers of the applications to which resources have been allocated from the priority linked lists.

Another objective of the embodiments of this disclosure is to provide an electronic device, including at least one processor and a memory in communication connection with the at least one processor, where the memory stores instructions that can be executed by the at least one processor, and the instructions are executed by the at least one processor to enable the at least one processor to: acquire a resource allocation request of multiple applications, where the requested resources in the resource allocation request are determined according to a current usage scenario; acquire the priority of each of the applications according to the current usage scenario; and allocate the requested resources to the applications successively according to the levels of the priorities.

According to the electronic device, the resources include a CPU resource, a graphics processor source and a dynamic memory bandwidth.

According to the electronic device, before the step of acquiring a resource allocation request of multiple applications, the priority of each of the applications in each usage scenario is pre-determined; and the resources are pre-allocated to each of the applications in each usage scenario.

According to the electronic device, the step of allocating the requested resources to the applications successively according to the levels of the priorities includes: establishing priority linked lists according to the number of levels of the priorities, where each of the priority linked lists corresponds to a different priority level; acquiring priority linked lists having the same priority levels as those of the applications according to the priorities of the applications; placing identifiers of the applications into the priority linked lists; and allocating resources to the applications corresponding to the identifiers in each of the priority linked lists successively according to the priority levels of the priority linked lists.

According to the electronic device, after the step of allocating the requested resources to the applications successively according to the levels of the priorities, the identifiers of the applications to which resources have been allocated are deleted from the priority linked lists.

Another objective of the embodiments of this disclosure is to provide a non-volatile computer storage medium storing computer executable instructions that, when executed by the electronic device, enable the electronic device to: acquire resource allocation requests of multiple applications, where the requested resources in the resource allocation requests are determined according to a current usage scenario; acquire the priority of each of the applications according to the current usage scenario; and allocate the requested resources to the applications successively according to the levels of the priorities.

According to the non-volatile computer storage medium, the resources include a CPU resource, a graphics processor resource and a dynamic memory bandwidth.

According to the non-volatile computer storage medium, before the step of acquiring resource allocation requests of multiple applications, the priority of each of the applications in each of the usage scenarios is pre-determined; and the resources are pre-allocated to each of the applications in each of the usage scenarios.

According to the non-volatile computer storage medium, the step of allocating the requested resources to the applications successively according to the levels of the priorities includes: establishing priority linked lists according to the number of the levels of the priorities, where each of the priority linked lists corresponds to a different level of priority; acquiring priority linked lists having the same levels of the priorities as those of the applications according to the priorities of the applications; placing identifiers of the applications into the priority linked lists; and allocating resources to the applications corresponding to the identifiers in each of the priority linked lists successively according to the levels of the priorities of the priority linked lists.

According to the non-volatile computer storage medium, after the step of allocating the requested resources to the applications successively according to the levels of the priorities, the identifiers of the applications to which resources have been allocated are deleted from the priority linked lists.

The method and electronic device for resource allocation provided by embodiments of this disclosure determine the priorities of applications requesting resource allocation and resources to be allocated according to different current usage scenarios, and allocate resources according to the priorities and the resources to be allocated. The method for allocating resources according to needs of usage scenarios can not only guarantee the performance of a terminal in various usage scenarios, but also better optimize the power saving in a single usage scenario. The overall endurance of a smart mobile terminal is a combination of endurance in single scenarios, and when the endurance is good in each of the single usage scenarios, the overall endurance time of a mobile phone will be greatly improved.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a method for resource allocation in accordance with Embodiment 1 of this disclosure;

FIG. 2 is a flow diagram of a method for allocating resources to applications according to priorities in accordance with Embodiment 1 of this disclosure;

FIG. 3 is a functional block diagram of a device for resource allocation in accordance with Embodiment 2 of this disclosure; and

FIG. 4 is a schematic diagram of a hardware structure of the electronic device for executing the method for resource allocation in accordance with Embodiment 4 of this disclosure.

### DETAILED DESCRIPTION

To make the objectives, the technical scheme and the advantages of the embodiments of this disclosure clearer, the technical scheme of this disclosure will be clearly and completely described hereinafter through implementation with reference to the accompanying drawings in the embodiments of this disclosure. Apparently, the embodiments described below are a part, but not all, of the embodiments of this disclosure.

### Embodiment 1

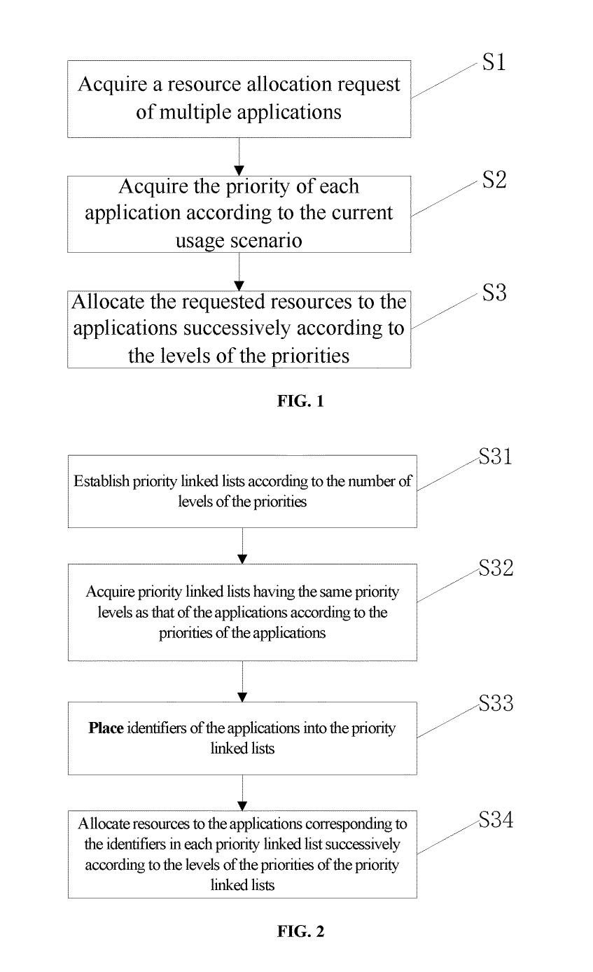

The present embodiment provides a method for resource allocation, and as shown in FIG. 1, the method includes the following steps:

S1: acquiring a resource allocation request of multiple applications, where the requested resources in the resource allocation request are determined according to a current usage scenario, and specifically, the resources include a CPU resource, a graphics processor resource and a dynamic memory bandwidth.

S2: acquiring the priority of each of the applications according to the current usage scenario. That is to say, the priority of each of the applications is set according to the needs of the current usage scenario, for example, if there is only a video playing disclosure in a visual interface of a current terminal, the priority of the video playing disclosure under the circumstance must be the highest, namely the smoothness of video playing needs to be guaranteed at first, and then background applications are considered, namely under the circumstance, the priorities of the background applications must be lower than the priority of the video playing. If the foreground disclosure of the current terminal is QQ, then under the circumstance, the priority of QQ is the highest, resources are preferentially allocated to QQ to guarantee its performance, and other background applications can be set with different priorities as needed.

S3: allocating the requested resources to the applications successively according to the levels of the priorities.

A method for resource allocation provided by the present embodiment determines the priorities of applications requesting resource allocation and resources to be allocated according to different current usage scenarios, and allocates resources according to the priorities and the resources to be allocated. The method for allocating resources according to needs of usage scenarios can not only guarantee the performance of a terminal in various usage scenarios, but also better optimize the power saving in a single usage scenario. The overall endurance of a smart mobile terminal is a combination of endurance in individual scenarios, and when the endurance is good in each of the individual scenarios, the overall endurance time of a mobile phone will be greatly improved.

Specifically, before step S1, namely before the step of acquiring a resource allocation request of multiple applications, the method also includes:

firstly, pre-determining the priority of each of the applications in each usage scenario; and

then, pre-allocating the resources to each of the applications in each usage scenario.

The method for allocating resources according to the needs of usage scenarios provided by the present embodiment can save electric energy and improve the endurance time on the premise of guaranteeing the user experience. The determination of the priority of each of the applications in each scenario and resources to be allocated is very important. Therefore, for each common usage scenario, used applications priorities of which are required to be determined, confirmation of the priority of each of the applications, and pre-allocated resources of each of the applications, including the types and sizes of the resources, are determined in advance, and may be specifically determined depending on actual usage requirements.

Specifically, as shown in FIG. 2, step S3, namely the step of allocating the requested resources to the applications successively according to the levels of the priorities, includes:

S31: establishing priority linked lists according to the number of the levels of the priorities, where each priority linked list corresponds to a different level of priority;

S32: acquiring priority linked lists having the same levels of the priorities as those of the applications according to the priorities of the applications;

S33: placing identifiers of the applications into the priority linked lists, namely placing the identifiers into the priority linked lists having the same priority levels as those of the applications; and

S34: allocating resources to the applications corresponding to the identifiers in each of the priority linked lists successively according to the levels of the priorities of the priority linked lists.

In the present embodiment, in order to accelerate the process of resource allocation, the priorities are divided into four levels, and correspondingly, four priority linked lists are established. Each disclosure corresponds to one identifier that may be a unique number; after an disclosure sends a resource allocation request according to the current terminal usage scenario, the resource allocation request includes the number of the disclosure and the resources requested in the current usage scenario, and may also include the type of the disclosure. After the resource allocation request is acquired, the priority of the disclosure in the current usage scenario is acquired, and then the number of the disclosure is placed into a corresponding priority linked list. In addition, the linked list with a high priority is first scanned to ensure that the applications with high priorities can obtain resources in time; if the linked list with the high priority is completely scanned, the linked list with a priority only lower than the priority is further scanned; and after all the linked lists are completely scanned, a resource allocation request of the disclosure is acquired again, which is performed successively and circularly.

Specifically, after step S3, namely after the step of allocating the requested resources to the applications successively according to the levels of the priorities, the method also includes: deleting the identifiers of the applications to which resources have been allocated in the priority linked lists.

In the present embodiment, this step is performed to acquire corresponding resources when opening the same disclosure by a user next time without causing conflicts. For example, for an disclosure running in background, if a user opens this disclosure, the priority of the disclosure is increased even to the highest level, and then the resources needed by the disclosure are also changed. In that way, the resource allocation request needs to be re-sent to allocate resources according to the priority and the requested resources at this time, so as to guarantee the smoothness of the disclosure and promote the user experience. Correspondingly, when an disclosure is hanging in background, less resources needs to be allocated accordingly, namely part of occupied resources needs to be released. However, after the disclosure is quitted, the resources occupied by the disclosure are required to be completely released.

### Embodiment 2

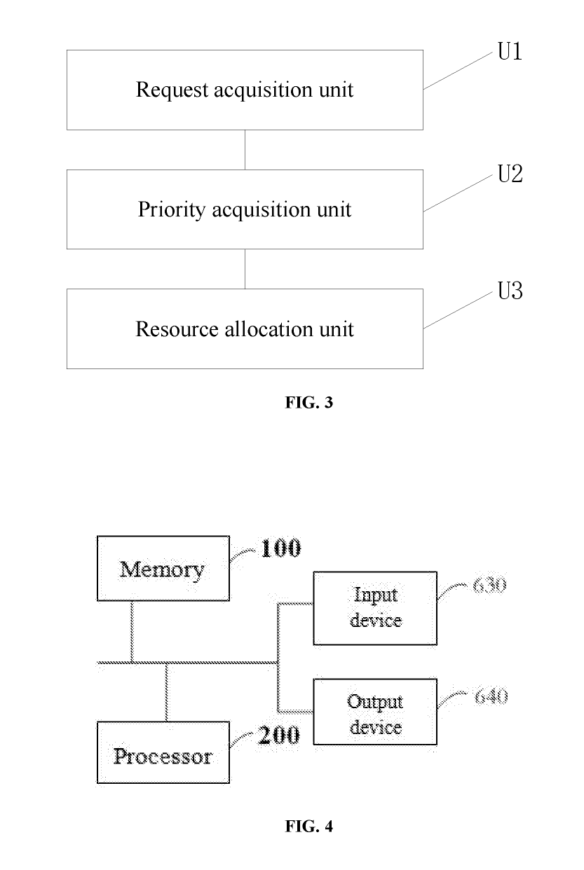

As shown in FIG. 3, the present embodiment provides a device for resource allocation, including: a request acquisition unit U1, for acquiring a resource allocation request of multiple applications, where the requested resources in the resource allocation request are determined according to a current usage scenario, and specifically, the resources include a CPU resource, a graphics processor resource and a dynamic memory bandwidth; a priority acquisition unit U2, for acquiring the priority of each disclosure according to the current usage scenario; and a resource allocation unit U3, for allocating the requested resources to the applications successively according to the levels of the priorities.

A device for resource allocation provided by the present embodiment determines the priorities of applications requesting resource allocation and resources to be allocated according to different current usage scenarios, and allocates resources according to the priorities and the resources to be allocated. The method for allocating resources according to needs of usage scenarios can not only guarantee the performance of a terminal in various usage scenarios, but also better optimize the power saving in a single usage scenario. The overall endurance of a smart mobile terminal is a combination of endurance in single scenarios, and when the endurance is good in every single usage scenario, the overall endurance time of a mobile phone will be greatly improved.

Specifically, the device also includes: a priority presetting unit, for pre-determining the priority of each disclosure in each usage scenario; and a resource pre-allocation unit, for pre-allocating the resources to each disclosure in each usage scenario.

Specifically, the resource allocation unit U3 includes: a linked list establishing subunit, for establishing priority linked lists according to the number of levels of the priorities, where each priority linked list corresponds to a different priority level; a linked list matching subunit, for acquiring priority linked lists having the same priority levels as those of the applications according to the priorities of the applications; an identifier inserting subunit, for placing identifiers of the applications into the priority linked lists; and an allocation subunit, for allocating resources to the applications corresponding to the identifiers in each priority linked list successively according to the priority levels of the priority linked lists.

Specifically, the device also includes: an identifier deleting unit, for deleting the identifiers of the applications to which resources have been allocated in the priority linked lists.

### Embodiment 3

The embodiment of this disclosure further provides a non-volatile computer storage medium, and computer executable instructions, when executed by the electronic device, enable the electronic device to: acquire resource allocation requests of multiple applications, where the requested resources in the resource allocation requests are determined according to a current usage scenario; acquire the priority of each of the applications according to the current usage scenario; and allocate the requested resources to the applications successively according to the levels of the priorities.

According to the non-volatile computer storage medium, the resources comprise a CPU resource, a graphics processor resource and a dynamic memory bandwidth.

According to the non-volatile computer storage medium, before the step of acquiring the resource allocation requests of multiple applications, the priority of each of the applications in each of the usage scenarios is pre-determined; and the resources are pre-allocated to each of the applications in each of the usage scenarios.

According to the non-volatile computer storage medium, the step of allocating the requested resources to the applications successively according to the levels of the priorities includes: establishing priority linked lists according to the number of the levels of the priorities, where each priority linked list corresponds to a different level of priority; acquiring priority linked lists having the same levels of the priorities as those of the applications according to the priorities of the applications; placing identifiers of the applications into the priority linked lists; and allocating resources to the applications corresponding to the identifiers in each of the priority linked lists successively according to the levels of the priorities of the priority linked lists.

According to the non-volatile computer storage medium, after the step of allocating the requested resources to the applications successively according to the levels of the priorities, the identifiers of the applications to which resources have been allocated are deleted from the priority linked lists.

### Embodiment 4

FIG. 4 shows a schematic diagram of a hardware structure of the electronic device for executing the method for resource allocation in the embodiment of this disclosure, and as shown in FIG. 4, the device includes one or more processors 200 and a memory 100, and one processor 200 is taken as an example in FIG. 4; and the electronic device for executing the method for resource allocation may also include an input device 630 and an output device 640.

The processor 200, the memory 100, the input device 630 and the output device 640 may be connected by virtue of a bus or in other ways, and bus connection is taken as an example in FIG. 4.

The memory 100, as a non-volatile computer readable storage medium, may be used for storing non-volatile software programs, non-volatile computer executable programs and modules, for example, program instructions/modules (e.g., a request acquisition unit U1, a priority acquisition unit U2, and a resource allocation unit U3 shown in FIG. 3) corresponding to the method for resource allocation in the embodiments of this disclosure. The processor 200 runs the non-volatile software programs, instructions and modules stored in the memory 100 so as to execute various functional applications and data processing of a server, thereby implementing the method for resource allocation in the abovementioned embodiments of the method.

The memory 100 may include a program storage area and a data storage area, where the program storage area may store an operating system and applications for at least one functions; and the data storage area may store data and the like created according to the use of the device for resource allocation. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the device for resource allocation through a network. An example of the network includes, but is not limited to, internet, intranet, LAN, mobile communication network, and the combinations thereof.

The input device 630 may receive input digit or character information, so as to generate a key signal input related to the user configuration and function control of the device for resource allocation. The output device 640 may include display devices such as a display screen.

The one or more modules are stored in the memory 100, and when executed by the one or more processors 200, perform the method for resource allocation in any one of the abovementioned embodiments of the method.

The abovementioned product can perform the method provided by the embodiments of this disclosure and has corresponding functional modules and beneficial effects for executing the method. For more technical details of this embodiment, please refer to the method provided by the embodiments of this disclosure.

The electronic device of the embodiments of this disclosure exists in many forms, including but not limited to:

(1) Mobile communication devices: the characteristic of this type of device is having a mobile communication function with a main goal of enabling voice and data communication. This type of terminal includes: smart phones (such as iPhone), multimedia phones, feature phones, low-end phones, etc.

(2) Ultra-mobile personal computer devices: this type of device belongs to the category of personal computers that have computing and processing functions and usually also have mobile internet access features. This type of terminal includes: PDA, MID, UMPC devices, etc., such as iPad.

(3) Portable entertainment devices: this type of device is able to display and play multimedia contents. This type of device includes: audio and video players (such as iPod), handheld game players, electronic books, intelligent toys, and portable vehicle navigation devices.

(4) Servers: devices providing computing services. The structure of a server includes a processor, a hard disk, an internal memory, an electronic device bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned device embodiments are only illustrative, where the units described as separate parts may be or may not be physically separated, the components shown as units may be or may not be physical units, i.e. may be located in one place, or may be distributed at multiple network units. According to actual needs, part of or all of the modules therein may be selected to realize the objectives of the technical scheme of the embodiment.

By abovementioned descriptions of the implementations, those skilled in the art can clearly understand that the various implementations may be implemented by means of software and a general hardware platform, or just by means of hardware. Based on such understanding, the abovementioned technical scheme in essence, or the part thereof making contribution to a related art, may be embodied in the form of a software product, and such computer software product may be stored in a computer readable storage medium such as an ROM/RAM, a magnetic disk or an optical disk, etc., and may include a plurality of instructions to enable a computer device (which may be a personal computer, a server, or a network device) to execute the methods described in the various embodiments or in some parts thereof.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of the various embodiments of this disclosure.

What is claimed is:

1. A method for resource allocation, comprising the following steps:
acquiring a resource allocation request of multiple applications, wherein the requested resources in the resource allocation request are determined according to a current usage scenario;
acquiring the priority of each of the applications according to the current usage scenario; and
allocating the requested resources to the applications successively according to the levels of the priorities.

2. The method according to claim 1, wherein the resources comprise a CPU resource, a graphics processor resource and a dynamic memory bandwidth.

3. The method according to claim 1, further comprising before the step of acquiring a resource allocation request of multiple applications:
pre-determining the priority of each of the applications in each of the usage scenarios; and
pre-allocating the resources to each of the applications in each of the usage scenarios.

4. The method according to claim 1, wherein the step of allocating the requested resources to the applications successively according to the levels of the priorities comprises:
establishing priority linked lists according to the number of the levels of the priorities, wherein each priority linked list corresponds to a different level of priority;
acquiring priority linked lists having the same levels of the priorities as those of the applications according to the priorities of the applications;
placing identifiers of the applications into the priority linked lists; and
allocating resources to the applications corresponding to the identifiers in each of the priority linked lists successively according to the levels of the priorities of the priority linked lists.

5. The method according to claim 1, further comprising after the step of allocating the requested resources to the applications successively according to the levels of the priorities:
deleting the identifiers of the applications to which resources have been allocated from the priority linked lists.

6. An electronic, comprising:
at least one processor, and
a memory in communication connection with the at least one processor,
wherein, the memory stores instructions that can be executed by the at least one processor, and the instructions are executed by the at least one processor to enable the at least one processor to:
acquire a resource allocation request of multiple applications, wherein the requested resources in the resource allocation request are determined according to a current usage scenario;
acquire the priority of each of the applications according to the current usage scenario; and
allocate the requested resources to the applications successively according to the levels of the priorities.

7. The electronic device according to claim 6, wherein the resources comprise a CPU resource, a graphics processor resource and a dynamic memory bandwidth.

8. The electronic device according to claim 6, wherein,
before the step of acquiring a resource allocation request of multiple applications, the priority of each disclosure in each usage scenario is pre-determined; and the resources are pre-allocated to each of the applications in each usage scenario.

9. The electronic device according to claim 6, wherein the step of allocating the requested resources to the applications successively according to the levels of the priorities comprises:
establishing priority linked lists according to the number of levels of the priorities, wherein each priority linked list corresponds to a different priority level;
acquiring priority linked lists having the same priority levels as those of the applications according to the priorities of the applications;
placing identifiers of the applications into the priority linked lists; and
allocating resources to the applications corresponding to the identifiers in each of the priority linked lists successively according to the priority levels of the priority linked lists.

10. The electronic device according to claim 6, wherein after the step of allocating the requested resources to the applications successively according to the levels of the priorities, the identifiers of the applications to which resources have been allocated are deleted from the priority linked lists.

11. A non-volatile computer storage medium, storing computer executable instructions that, when executed by the electronic device, enable the electronic device to: acquire a resource allocation request of multiple applications, wherein the requested resources in the resource allocation request are determined according to a current usage scenario;
acquire the priority of each of the applications according to the current usage scenario; and
allocate the requested resources to the applications successively according to the levels of the priorities.

12. The non-volatile computer storage medium according to claim 11, wherein the resources comprise a CPU resource, a graphics processor resource and a dynamic memory bandwidth.

13. The non-volatile computer storage medium according to claim 11, wherein before the step of acquiring a resource allocation request of multiple applications, the priority of each of the applications in each of the usage scenarios is pre-determined; and the resources are pre-allocated to each of the applications in each of the usage scenarios.

14. The non-volatile computer storage medium according to claim 11, wherein the step of allocating the requested resources to the applications successively according to the levels of the priorities comprises: establishing priority linked lists according to the number of the levels of the priorities, wherein each of the priority linked lists corresponds to a different level of priority;
acquiring priority linked lists having the same levels of the priorities as those of the applications according to the priorities of the applications;
placing identifiers of the applications into the priority linked lists; and
allocating resources to the applications corresponding to the identifiers in each of the priority linked lists successively according to the levels of the priorities of the priority linked lists.

15. The non-volatile computer storage medium according to claim 11, wherein, after the step of allocating the requested resources to the applications successively according to the levels of the priorities, the identifiers of the applications to which resources have been allocated are deleted from the priority linked lists.
